(19) United States
(12) Patent Application Publication
(10) Pub. No.: US 2012/0255331 A1
(43) Pub. Date: Oct. 11, 2012

(54) Ring Security Device

(75) Inventor: Vark Markarian, JR., Cranston, RI (US)

(73) Assignee: Contempo Card, Providence, RI (US)

(21) Appl. No.: 13/082,656

(22) Filed: Apr. 8, 2011

(51) Int. Cl. E05B 73/00

(52) U.S. Cl. 70/14

(57) ABSTRACT

A merchandise security device is adapted to hold an item of merchandise to a merchandise display device to enable the merchandise to be displayed and provide an impediment to prevent the ring from being removed from the display device. The security device is adapted to freely rotate in a hole in the display device such that twisting the merchandise causes rotation of the merchandise without tearing it from the display device packaging. The security device can include two holes to allow the merchandise to be strapped or tied to the security device The security device can include a post on one of its surfaces that supports the fastening strap away from security device so a cutting device can be positioned to cut the merchandise free after purchase.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is direct to a ring security device. More specifically, the present invention is directed to a device adapted to hold a ring to a merchandise display device to enable the ring to be displayed and provide an impediment to prevent the ring from being removed from the display device.

2. Description of the Prior Art

Typically, rings and other similar types of merchandise, including other jewelry, are fastened to displays. The display typically includes a paper or plastic card that can be folded and/or provided with one or more holes to allow the product to be displayed on a shelf or hung from a hook or rod. The display card can include one or more anti-theft devices, such as a so-called Sensormatic™ tag or other similar tags that help to deter theft of the merchandise. Typically, the rings are attached to the display card using a, twist-tie, a ty-wrap or a cable tie that wraps around the ring and passes through two holes in the display card. Unfortunately, the display card material is easily torn or broken and the ring (or other product) can be easily removed from the display card and the anti-theft tag. As a result, there is a need for an improved method of attaching the ring to the display card.

### SUMMARY

The present invention is directed to a method and system for securing an item of merchandise, such as a ring or other jewelry to a display device. The display device can include a hanging display card, a display tag, an insert for a display case, or an insert for a box. In accordance with the invention, an item of merchandise can be securely fastened to a fastening or security device which is adapted to fit in a hole in the display device, without being pulled through. The fastening device can be adapted to rotate in the hole making it difficult to break the merchandise away from the display device by twisting. The security device and/or the display device can include one or more anti-theft devices, such as Sensormatic™ tags or RFID devices.

In accordance with one embodiment of the invention, the a merchandise security device includes a body extending along a longitudinal axis from a front face to a back face. The body can include a first portion having a first diameter and a second portion having a second diameter, wherein the second diameter of the second portion is greater than the first diameter of the first portion. The body can further include at least two holes extending through the body from the front face to the back face, extending substantially parallel to the longitudinal axis. The body can further include a groove having a third diameter smaller than the first diameter.

The groove diameter can be substantially the same size or slightly smaller than a hole in the display device used with the security device to display merchandise attached thereto. In one embodiment of the invention, the first portion can be pushed through the hole in the display device, such that the display device is captured in the groove of the security device. In this configuration, the merchandise can be fastened to the security device by a fastening wrap, such as a Ty-Rap™ or cable tie (or other fastening device), to prevent it from being separated from the display which can include one or more anti-theft devices, such a Sensormatic tag or other tag. Because the security device can, in some embodiments, turn freely in the hole in the display device, the merchandise cannot be easily separated from the display device by twisting or pulling. In some embodiments of the invention, the security device can include a post extending from the back face of the security device to position the fastening wrap away from the security device and enable a cutting device to engage the fastening wrap to cut it away after the merchandise is sold.

In some embodiments, the security device can be round in shape and in other embodiments, the security device can be square, rectangular or any other polygonal shape. In some embodiments, the groove can extend around the entire circumference of the body or, in other embodiments, the groove can be discontinuous and only extend around portions of the body. In some embodiments, the front face can include a concave surface to better support and engage the merchandise attached thereto. In other embodiments, include a convex surface to better support and engage the merchandise attached thereto. The security device can be made of virtually any sturdy material.

In other embodiments of the invention, the second portion can have a substantially larger diameter that the first portion and back face can be sufficiently large to enable an anti-theft device, such as a Sensormatic tag or RFID tag to be attached or embedded in the device. Thus, if security device is separated from the display device, the anti-theft device will still remain fastened to the merchandise.

These and other capabilities of the invention, along with the invention itself, will be more fully understood after a review of the following figures, detailed description, and claims.

### BRIEF DESCRIPTION OF THE FIGURES

FIG. 1 shows a front view of a security device according to one embodiment of the invention.

FIG. 2 shows a side view of a security device according to the embodiment of the invention shown in FIG. 1.

FIG. 3 shows a front view of a security device inserted in a display device according to one embodiment of the invention.

FIGS. 4-5 show front and side views, respectively, of a ring mounted on a security device and display device according to one embodiment of the invention.

### DETAILED DESCRIPTION OF PREFERRED EMBODIMENTS

The present invention is directed to a method and system for securing an item of merchandise, such as a ring or other jewelry, to a display device such as a display card, a display tag, an insert for a display case, or an insert for a box. The display device can be any packaging used to secure an item of merchandise. In accordance with the invention, an item of merchandise can be securely fastened to a fastening or security device which is adapted to fit in a hole in the display device, without being pulled through. The fastening device can be adapted to rotate in the hole making it difficult to break the merchandise away from the display device by twisting. The security device and/or the display device can include one or more anti-theft devices, such as Sensormatic™ tags or RFID devices.

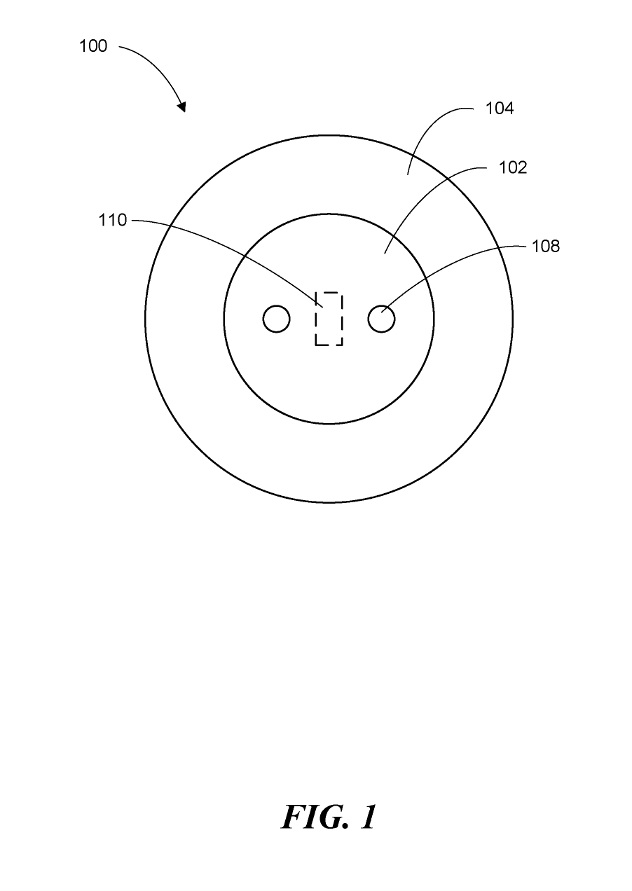

FIGS. 1-5 illustrate one embodiment of the present invention. The drawings and the accompanying description are intended to provide a better understanding of the present invention. The drawings are for illustration purposes and are not necessarily to scale.

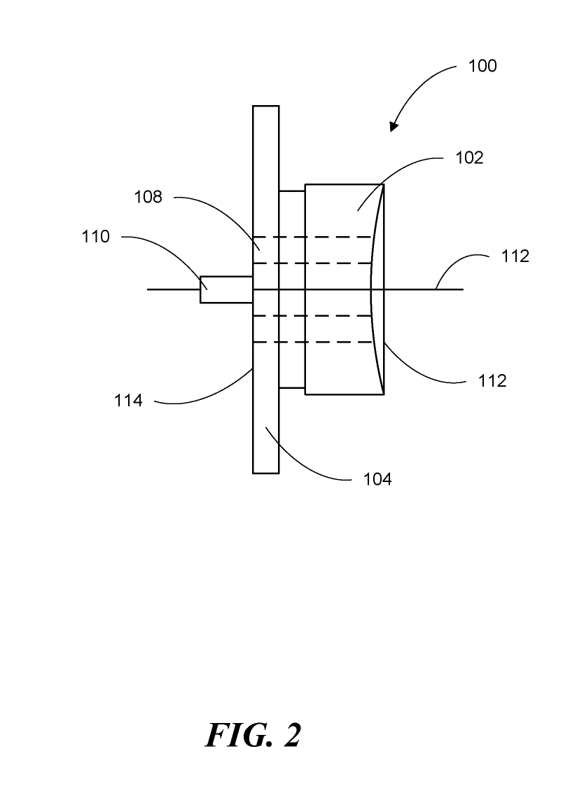

FIG. 1 shows a view of the front face 112 of a security device 100 according to an embodiment of the present invention and FIG. 2 shows a side of the security device 100 according to an embodiment of the present invention. The security device 100 can include a body extending along a longitudinal axis 120 from a front face 112, to back face 114, having a first portion 102 adjacent the front face, a second portion 104 adjacent the back face, and at least two holes 108 extending through the body from the front face 112 to the back face 114, substantially parallel to the longitudinal axis 120. The first portion 102 can have a first diameter or extent and the second portion 104 can have second diameter or extent, and wherein the second diameter is greater than the first diameter. The security device 100 can further include a post 110 that extends from the back face 114. The post 110 can support the fastening wrap away from the back face, so it can be easily cut away from the merchandise after the sale.

In accordance with one embodiment of the invention, the body of the security device 100 can include a groove 106 positioned between the first portion 102 and the second portion 104. The groove can have a third diameter that is smaller than the first diameter.

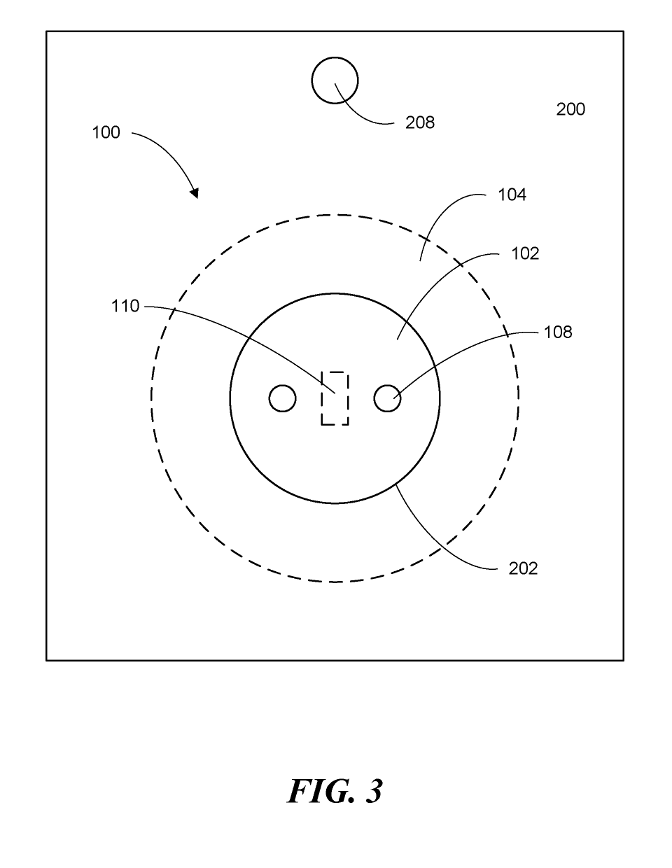

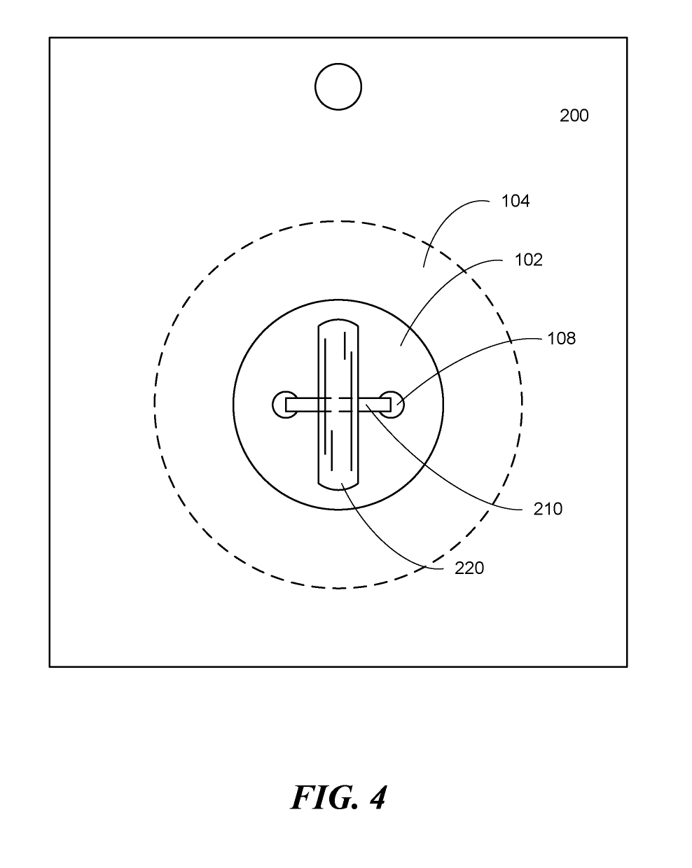

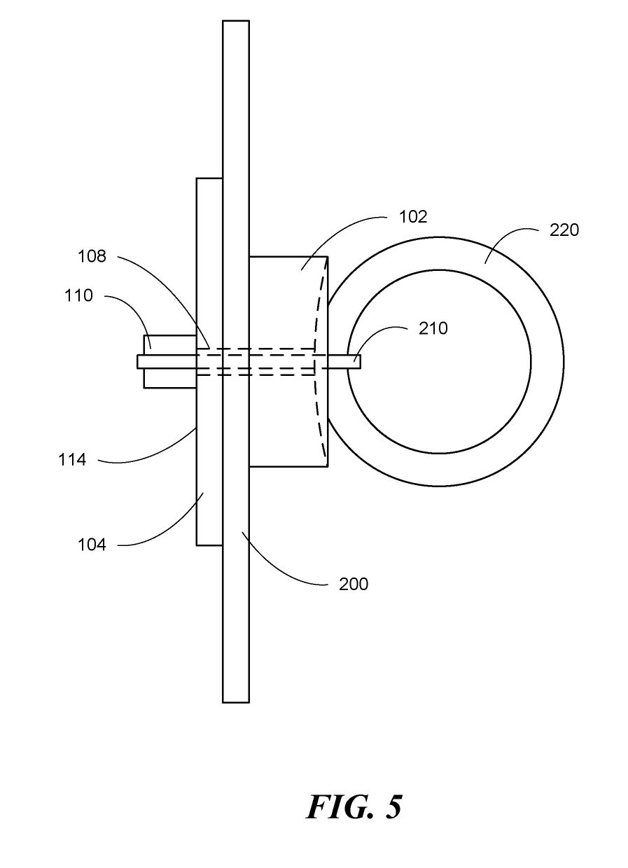

The security device 100 can be used with a display device 200 to hold and display merchandise as further shown in FIGS. 4 and 5. As shown in FIG. 3, the first portion 102 of the security device 100 can be sized or adapted to fit in a hole 202 in the display device 200. In the embodiment shown in FIG. 3, the hole 202 in the display device 200 aligns with the groove 106 of the security device 100. In this embodiment, the size of the hole 202 is slightly smaller than the first diameter of the first portion 102 and the same size or slightly larger than the third diameter of the groove 106, allowing the display device 200 to be snapped into and retained by the groove 106. The size of the hole 202 is substantially smaller than the second diameter of the second portion 104. In this configuration, the security device 100 can rotate in the hole 202 and the second portion 104 prevents the security device 100 from being pulled through the hole 202 in the display device 200.

In an alternative embodiment, the security device 100 can be provided without the groove 106 and retained in place by one or more fastening elements. The fastening elements can include an elastic band or O-ring that can slipped or stretched over the outer surface of the first portion after it has been inserted through the hold in the display device 200, to retain the security device 100 in place. In other embodiments, the first portion 102 can include a transverse hole (not shown) through which a pin (for example, similar to a cotter or clevis pin) can inserted, preventing the security device 100 from being removed from the display device without ripping or distorting the display device 200.

FIGS. 4 and 5 show an embodiment of the invention in use, securing a ring 220 to a display device 200. In this embodiment, first portion 102 of the security device 100 can be inserted though a hole 202 of a display device 200 and snapped into a groove 106 in the security device 100. A fastening wrap 210, such as a Ty-Rap™ or other secure fastening device, can be used to strap the ring to the front face 112 of the security device 100. The second portion 104 can have a substantially larger diameter than the hole 202 in the display device 200 and a front surface of the second portion can bear against the back of the display device 200. Because the hole 202 in the display device 200 and the groove 106 are approximately the same size or non-interfering in size, the security device 100 can rotate in-place with respect to the display device 200. Thus, the ring cannot be easily separated from the display device 200 by merely twisting the ring and ripping the fastening wrap through the display device 200.

FIG. 5 shows a side view of the security device 100 engaged by a display device 200, with a ring 220 fastened to the front surface 12 of the security device 100 by fastening wrap 210. As shown in FIG. 5, the back face includes post 110 and fastening wrap 210 is wrapped around the post 110 supporting a portion of the fastening wrap 210 away from the back face 114 so that a cutting tool, such as a scissors or knife can easily be inserted between the fastening wrap 201 and the back face 114 to cut the ring 220 free from the packaging after the product is sold.

In accordance with some embodiments of the present invention, the first portion 102 can have a first diameter in the range from less than 0.25 inches to 3 inches or more and the second portion 104 can have a second diameter in the range from less than 0.3 inches to 4 inches or more. While the groove 106, can be optional, when it is provided, the groove 106 can have a third diameter in the range from less than 0.2 to 2.9 inches or more. The length of the first portion 102 can be in the range from less than 0.05 to 0.25 inches, the length of the section portion 104 can be in the range from less than 0.05 to 0.25 inches, and the width of the groove 106 can be in the range from less than 0.03 to 0.1 inches. As one of ordinary skill will appreciate, the size of the security device 100 can be selected based on the size and characteristics of the item of merchandise to be attached to it and the characteristics of the display device 200 into which it is inserted. Further, the relative sizes of the third diameter of the groove 106 relative to the first diameter of the first portion can determined from information about display device 200 and the size of the hole. While the post 110 can be optional, when provided, the post 110 can extend from less than 0.0625 inches to 0.25 inches from the back face and be in range from less than 0.03125 inches to 0.125 inches thick and from less than 0.0625 inches to 0.25 inches wide.

In one embodiment of the invention, preferably, the first diameter of the first portion is 0.39 inches and the second diameter of the second portion is 0.585 inches and the third diameter of the groove is approximately 0.38 inches.

In accordance with some embodiments, the security device can be molded or machined from any wood, plastic or metal material. In some embodiments, the security device can be molded or machined from a plastic material, such as, Delrin™ or Nylon (both available from Dupont Plastics, Wilmington, Del.), or ABS (acrylonitrile butadiene styrene), PP (polypropylene), PET or PETE (polyethylene terephthalate), PET copolymers, such as PETG (available from Eastman Chemical, Kingsport, Tenn. and SK Chemicals, Fort Lee, N.J.), PVC (polyvinylchloride), HDPE (High Density Polyethylene), LDPE (Low Density Polyethylene), and PS (polystyrene) as well as other plastic, rubber and polymer materials. In other embodiments, the security device can be molded or machined from metal materials, such as steel, aluminum, cast iron, brass, bronze, and other metals and metal alloys.

In accordance with the invention, the display device 200 can include a sheet material, such as, paper, cardboard or plastic materials as well as a combination of the materials. In some embodiments, the display device 200 can include a laminate of one or more plastic materials (including combinations of different plastic materials) or a combination of paper and plastic materials.

While the security device 100 is shown having a circular or round shape, the first portion 102 and/or the second portion 104 can be square, rectangular or any other polygonal shape as well as an oval or other circular or similar shape. Further, the hole 202 in the display device 200 can also be square, rectangular or any other polygonal shape as well as an oval or other circular or similar shape. Further, as one of ordinary skill in the art would appreciate, the relative size and shape of the first portion 102 and the hole 202 can be selected to enable the security device 100 to freely turn in hole 202, to turn, but with resistance in hold 202 or have non-round complementary shape that prevents relative rotation (i.e, the first portion (and/or the groove) and the hole are square or rectangular.)

In some embodiments of the invention, the security device 100 can include an anti-theft tag, such as a Sensormatic tag or an RFID tag. These tags can be detected by anti-theft sensors positioned adjacent the doors to retail establishments indicating (such as by an audible alarm) that the anti-theft tag is brought close the door. The anti-theft tag can be molded into the security device 100 or adhered to the back face of the security device 100. In some embodiments, the anti-theft tag can be fastened to the back face 114 of the security device 100, between the holes (e.g. in the place of the post 110).

Further, the material used for the security device 100 can include chemicals and substances that provide additional benefits. For example, the plastic used for the security device 100 can include an anti-tarnish chemical to reduce the tendency of jewelry type merchandise from tarnishing while on display. The plastic used can also include anti-bacterial chemicals to reduce germs that come in contact with the merchandise during handling by employees and customers.

The anti-theft tag can be provided in or on the security device 100, instead of or in addition to, in or on the display device 200.

These and other embodiments are within the scope and spirit of the invention.

Further, while the description above refers to the invention, the description may include more than one invention.

What is claimed is:

1. A merchandise security device comprising:
a body extending along a longitudinal axis from a front face to a back face, the body including a first portion having a first diameter and a second portion having a second diameter, wherein the second diameter of the second portion is greater than the first diameter of the first portion; and
at least two holes through the body extending from the front face to the back face, substantially parallel to the longitudinal axis.

2. A merchandise security device according to claim 1 further comprising a post extending from the back face, substantially parallel to the longitudinal axis.

3. A merchandise security device according to claim 2 wherein the post extends to a position between the two holes.

4. A merchandise security device according to claim 1 wherein the first face includes a concave surface.

5. A merchandise security device according to claim 1 further comprising a groove in the body between the first portion and the second portion, the groove having a third diameter smaller than the first diameter.

6. A merchandise security device according to claim 1 wherein the first portion of the body is round.

7. A merchandise security device according to claim 1 wherein the second portion of the body is round.

8. A merchandise security device according to claim 1 wherein the second portion of the body is a polygonal shape.

9. A merchandise security device according to claim 1 wherein the first portion of the body has a polygonal shape.

10. A merchandise security device according to claim 1 further comprising a display device including a sheet material having a hole and wherein the first portion of the body extends through the hold in the sheet material.

11. A merchandise security device according to claim 1 wherein the body is made from a plastic material.

12. A merchandise security device according to claim 11 wherein the plastic material includes one or more of Delrin™, nylon, ABS (acrylonitrile butadiene styrene), PP (polypropylene), PET (polyethylene terephthalate), PVC (polyvinylchloride), HDPE (High Density Polyethylene), and LDPE (Low Density Polyethylene), and PS (polystyrene).

13. A merchandise security device according to claim 1 wherein the body is made from a metal material.

14. A merchandise security device according to claim 13 wherein the metal material includes one or more of steel, aluminum, cast iron, brass, bronze, and metal alloys.
